(19) United States
(12) Patent Application Publication
(10) Pub. No.: US 2002/0006228 A1
(43) Pub. Date: Jan. 17, 2002

(54) Data decoding apparatus and method of same

(76) Inventors: Daisuke Suzuki, Kanagawa (JP); Daisuke Koyanagi, Kanagawa (JP)

Correspondence Address: FROMMER LAWRENCE & HAUG LLP, 745 FIFTH AVENUE, NEW YORK, NY, 10151, US

(21) Appl. No.: 09/899,717

(22) Filed: Jul. 5, 2001

(30) Foreign Application Priority Data
Jul. 6, 2000 (JP) P2000-205106

(51) Int. Cl. G06K 9/38; G06K 9/46; G06K 9/36

(52) U.S. Cl. 382/233; 382/246; 382/250; 382/251

(57) ABSTRACT

A data decoding apparatus having a simple circuit configuration and processing data at a high speed by detecting and deleting a marker code by a simple circuit at a high speed. A marker remover deletes the marker from a data stream containing the input marker and generates a data stream having 32 bits of fixed length comprised by only data. Also, 4 bits of a marker flag indicating a type and a location of a marker are generated and added to each data. The 32 bits of data are input via a buffer RAM to a Huffman decoder, the restart marker is detected from the marker flag, and the decoding is carried out while appropriately resetting the DC component value based on this. At the decoding, processing for deleting the restart marker in the data string becomes unnecessary, thus the decoded data can be successively output. Also, the circuit configuration becomes simple too.

### BACKGROUND OF THE INVENTION

1. Field of the Invention

The present invention relates to a data decoding apparatus and a decoding method for decoding compressed and encoded data where control codes and a marker are arranged in a data stream of for example still image data compressed and encoded by JPEG (color still image encoding system of the Joint Photographic Experts Group) at a high speed by a circuit having a simple structure and simple processing.

2. Description of the Related Art

There are known various systems for encoding image data, audio data, etc. The JPEG is a representative example thereof being widely used for encoding still images.

In the discrete cosine transformation (DCT) system employed in the JPEG, an image is first divided into units of blocks of 8×8 pixels referred to as minimum coded units (MCU). DCT is carried out in block units to produce 64 DCT coefficients. To reduce the amount of information, a DC component of a DCT coefficient is expressed utilizing a correlation between blocks by a differential value from one previous block. For this reason, if an error occurs in the data due to a certain cause when transferring the JPEG compressed and encoded data, it ends up having a large influence upon the following blocks. In order to prevent the above defect, a marker for clearing a held DC component value can be inserted into the bit stream for every few MCU of the JPEG image data. This will be referred to as a restart marker (RSTm).

In the JPEG, various markers are defined other than this. These are expressed by 2-byte codes starting with FFh (h indicates a hexadecimal notation).

For example, in the case of an RSTm, not only are codes such as FFD0h to FFD7h allocated, but also a code FFD8 is allocated to a marker referred to as a “start of image” (SOI) indicating the start of one image and a code FFD9h to a marker referred to as an “end of image” (EOI) indicating the end of the image.

Summarizing the disadvantage to be solved by the invention, when the data FFh is generated in the encoded data, if simply arranged in the bit stream in units of one byte, it is not possible to discriminate between a marker code or data. Therefore, data is discriminated from a marker code by adding a bit 00h next to FFh.

As a result, in a decoding apparatus for decoding encoded data of such a configuration, it is necessary to discriminate between a marker code and data, delete the marker code from the data stream, recompose only the string of data, and then perform an actual decoding.

Such processing has become a cause hindering facilitation of the decoding, simplification of the circuit configuration of the decoding apparatus, and shortening of the decoding time.

### SUMMARY OF THE INVENTION

An object of the present invention is to provide a data decoding apparatus having a simple circuit configuration and performing processing at a high speed by detecting and deleting a marker code at a high speed by a simple circuit.

Another object of the present invention is to provide a method for decoding data with a simple circuit configuration and a high processing speed by detecting and deleting a marker code at a high speed by a simple circuit.

To achieve the first object of the present invention, according to a first aspect of the present invention, there is provided a data decoding apparatus provided with an additional data detecting means for detecting additional data from an encoded data stream comprised of encoded data and additional data as a series of data, an additional data deleting means for deleting said additional data from said encoded data stream, an additional data flag generating means for generating an additional data flag indicating a type and a position of said detected additional data based on said detection result, and a decoding means for performing predetermined processing with respect to the encoded data stream from which said additional data is deleted based on said generated additional data flag and performing the decoding.

Preferably, said additional data flag generating means selects additional data required in the decoding in said decoding means from said detected additional data and generates said additional data flag with respect to only the related selected additional data.

More preferably, said encoded data is encoded data utilizing a differential value from predetermined reference data, said additional data is control data for resetting said reference data, and said decoding means resets the reference data at a predetermined location added by said additional data flag with respect to said encoded data stream and decodes the encoded data utilizing said differential value.

Specifically, said encoded data stream is a data stream obtained by processing a desired still image for every predetermined unit area by discrete cosine transformation, quantization, variable length coding, insertion of predetermined additional data, and transformation to a string of fixed length data having a predetermined bit length, and said decoding means extracts said variable length coded data from said data stream, decodes the related encoded data by variable length decoding, and restores the string of the discrete cosine transformed and quantized data.

To achieve the second object of the present invention, according to a second aspect of the present invention, there is provided a decoding method comprised of the steps of detecting additional data from an encoded data stream comprised of encoded data and additional data as a series of data, deleting said additional data from said encoded data stream, generating an additional data flag indicating a type and a position of said detected additional data based on said detection result, and performing predetermined processing with respect to the encoded data stream from which said additional data is deleted based on said generated additional data flag and performing the decoding.

### BRIEF DESCRIPTION OF THE DRAWINGS

These and other objects and features of the present invention will be more apparent from the following description given with reference to the accompanying drawings, wherein:

FIG. 1 is a block diagram of the configuration of a JPEG decoding apparatus according to a first embodiment of the present invention;

FIG. 2 is a block diagram of the configuration of a Huffman decoder of the JPEG decoding apparatus shown in FIG. 1;

FIG. 3 is a diagram for explaining calculation of fill bits and a fill bit length;

FIGS. 4A to 4M are timing charts for explaining an operation of the Huffman decoder shown in FIG. 2;

FIG. 5 is a block diagram of the configuration of a JPEG decoding apparatus according to a second embodiment of the present invention;

FIG. 6 is a diagram for explaining a configuration of the data generated in a restart marker remover shown in FIG. 5;

FIG. 7 is a diagram for explaining a restart marker flag;

FIG. 8 is a block diagram of the configuration of the restart marker remover of the JPEG decoding apparatus shown in FIG. 5;

FIG. 9 is a block diagram of the configuration of the Huffman decoder of the JPEG decoding apparatus shown in FIG. 5; and

FIGS. 10A to 10K are timing charts for explaining the operation of the Huffman decoder shown in FIG. 9.

### DESCRIPTION OF THE PREFERRED EMBODIMENTS

First Embodiment

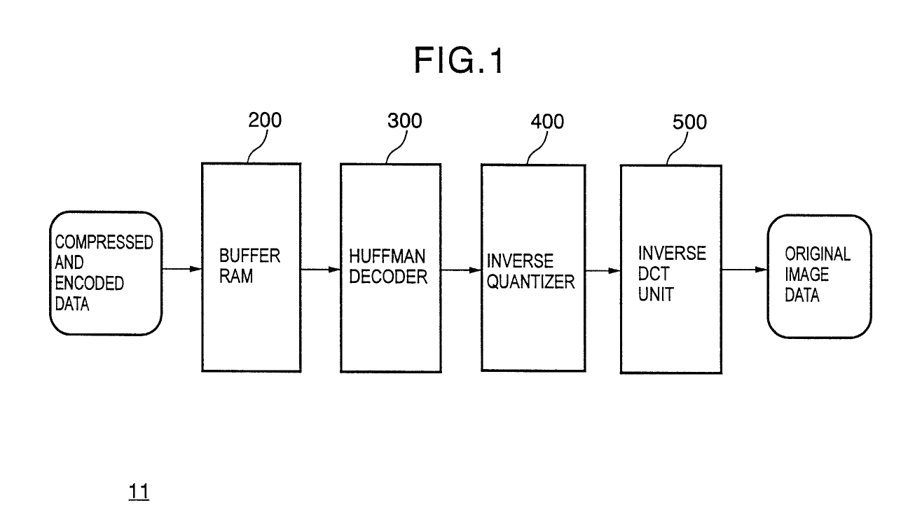

First, an explanation will be made of a JPEG decoding apparatus of a first embodiment of the present invention by referring to FIG. 1 to FIG. 4M.

First, an explanation will be made of the overall configuration of the JPEG decoding apparatus.

FIG. 1 is a block diagram of the configuration of JPEG decoding apparatus 11 of the present embodiment.

The JPEG decoding apparatus 11 has buffer random access memory (RAM) 200, Huffman decoder 300, inverse quantizer 400, and inverse DCT unit 500.

The buffer RAM 200 temporarily stores the input JPEG encoded data and sequentially outputs it to the Huffman decoder 300 upon request.

The Huffman decoder 300 sequentially reads the compressed and encoded data stored in the buffer RAM 200, that is, the Huffman encoded bit stream, decodes it, and outputs it to the inverse quantizer 400.

The inverse quantizer 400 inversely quantizes the encoded data input from the Huffman decoder 300, generates a string of DCT coefficients, and outputs the same to the inverse DCT unit 500.

The inverse DCT unit 500 performs inverse DCT with respect to the DCT coefficients input from the inverse quantizer 400, generates pixel data, and outputs the same as the decoded image data.

Next, a detailed explanation will be made of the configuration and operation of the Huffman decoder 300 according to the present invention.

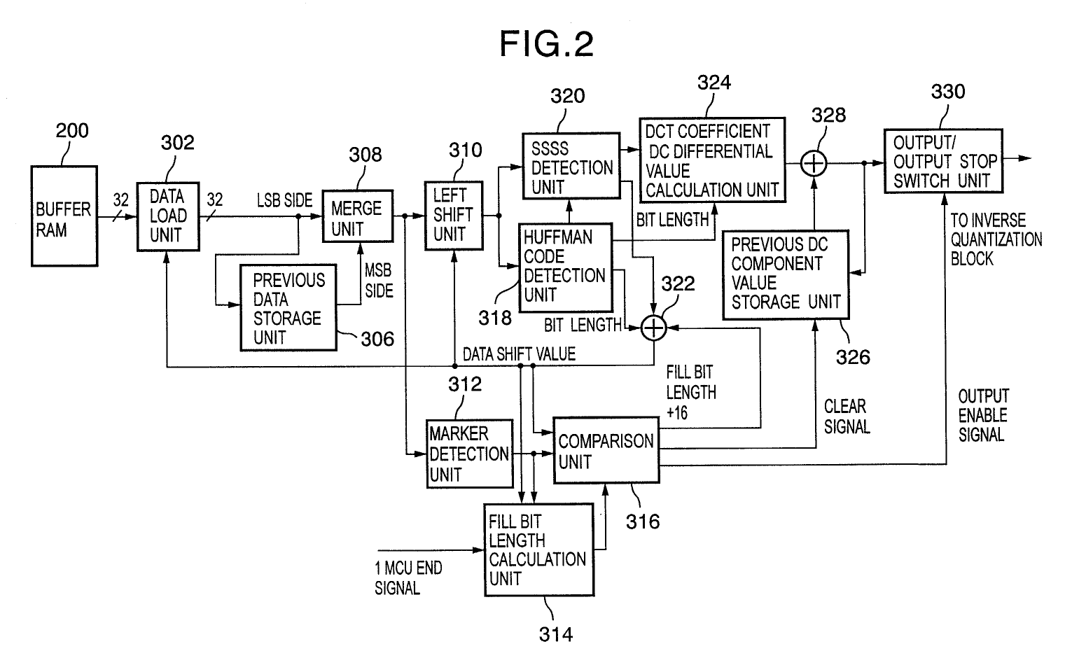

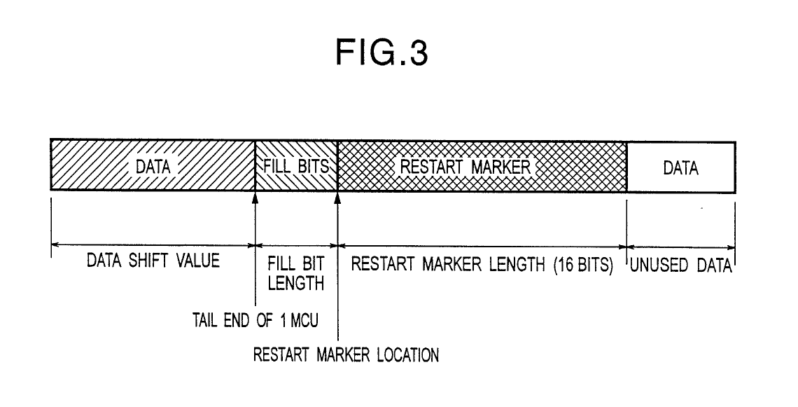

First, an explanation will be made of the configuration of the Huffman decoder 300 by referring to FIG. 2 and FIG. 3.

FIG. 2 is a block diagram of the configuration of the Huffman decoder 300.

The Huffman decoder 300 has data load unit 302, previous data storage unit 306, merge unit 308, left shift unit 310, marker detection unit 312, fill bit length calculation unit 314, comparison unit 316, Huffman code detection unit 318, category detection unit (SSSS detection unit) 320, adder 322, DCT coefficient and/or DC differential value calculation unit 324, previous DC component value storage unit 326, adder 328, and output/output stop switch unit 330.

The data load unit 302 sequentially reads data in 32-bit amounts from the buffer RAM 200 and outputs the same to the previous data storage unit 306 and the merge unit 308. The data load unit 302 reads the next data from the buffer RAM 200 when the data shift value input from the adder 322 becomes more than the bit length of the data to be loaded, that is, where it becomes 32 or more.

The previous data storage unit 306 temporarily stores the data read at the data load unit 302 and outputs the same to the merge unit 308.

The merge unit 308 merges the data read at the data load unit 302 and the data read from the buffer RAM 200 the previous time which is stored in the previous data storage unit 306 to generate 64 bits of data and outputs the same to the left shift unit 310 and the marker detection unit 312.

When reading the variable length data by fixed lengths, sometimes one set of data is arranged across over two sets of fixed length data. Such merger is carried out for this reason to combine the two sets of data and thereby prevent a state where the data to be processed is split in the middle.

Note that, at this time, the merge unit 308 combines the data so that the data read the previous time which is stored in the previous data storage unit 306 becomes the MSB side, and the data read at the current time which is input from the data load unit 302 becomes the LSB side.

The left shift unit 310 shifts the 64 bits of data merged at the merge unit 308 to the MSB side by exactly the data shift value input from the adder 322 and outputs the upper significant 16 bits of the shift data to the Huffman code detection unit 318 and the SSSS detection unit 320.

The marker detection unit 312 detects whether or not there is a restart marker in the upper significant 32 bits of 64 bits of data merged at the merge unit 308 and outputs the information of the detection result and the existing location to the fill bit length calculation unit 314 and the comparison unit 316.

The fill bit length calculation unit 314 calculates the fill bit length based on the location where the restart marker exists input from the marker detection unit 312 and the data shift value calculated at the adder 322 and outputs the same to the comparison unit 316.

Fill bits are data for filling a space between the tail end of the data of 1 MCU and the restart marker and can be detected by a signal separately input from the outside whether or not the processed data is data on the tail end of 1 MCU. Accordingly, the fill bit length calculation unit 314 can find the fill bit length by subtracting the data shift value output from the adder 322 from the location where the restart marker exists input from the marker detection unit 312 when processing the data on the tail end of 1 MCU.

The comparison unit 316 compares the value obtained by adding the data shift value input from the adder 322 and the fill bit length input from the fill bit length calculation unit 314 with the location where the restart marker exists input from the marker detection unit 312 and outputs a value obtained by adding the bit length of the fill bit and the bit length of restart marker (fixed to 16 bits) to the adder 322 where they are equal.

This state is the case where the data merged at the merge unit 308 exhibits the structure as shown in FIG. 3. Accordingly, by adding the bit length of the fill bits and the bit length of the restart marker (fixed to 16 bits) to the adder 322 calculating the data shift value, the next data can be processed while ignoring these fill bits and restart marker.

Also, the comparison unit 316 outputs a clear signal to the previous DC component value storage unit 326 to clear the DC component when detecting this state, that is, where the restart marker is detected.

Further, the comparison unit 316 generates the output enable signal and applies this to the output/output stop switch unit 330 when detecting this state. The comparison unit 316 validates the output when the data is sequentially shifted, referred to, and processed, but in the state as mentioned above, the restart marker is processed, that is, data which cannot be used as data of the cycle for deleting the restart marker is processed. For this reason, in the next cycle, the output of the output/output stop switch unit 330 is controlled so that the output data becomes invalid.

The Huffman code detection unit 318 detects and decodes the corresponding Huffman code from the data to be decoded input from the left shift unit 310 and outputs the same to the SSSS detection unit 320 and the DCT coefficient and/or DC differential value calculation unit 324.

Also, for the AC component, it detects and decodes the corresponding Huffman code from the data to be decoded input from the left shift unit 310, acquires an encoded element symbol RS, and outputs the same to the SSSS detection unit 320 and the DCT coefficient and/or DC differential value calculation unit 324.

Note that, in any case, the data having the bit length of the read Huffman code is output to the adder 322.

The SSSS detection unit 320 detects the category SSSS of the encoded element based on the Huffman code detected at the Huffman code detection unit 318 for the DC component, reads SSSS bits' worth of the additional data from the data to be decoded input from the left shift unit 310, and outputs the same as the DC differential value to the DCT coefficient and/or DC differential value calculation unit 324.

Also, for the AC component, it finds the AC component category SSSS and the zero run length RRRR from the encoded element symbol RS detected at the Huffman code detection unit 318. Then, if the category SSSS is not 0, it reads out the additional data and outputs the same together with the category SSSS and the run length RRRR to the DCT coefficient and/or DC differential value calculation unit 324.

Note that, in any case, it outputs the data of the bit length of the read additional bits to the adder 322.

The adder 322 adds all of the data of the bit lengths of the processed data input from the Huffman code detection unit 318 and the SSSS detection unit 320 and the data of the bit length of the data portion to be ignored input from the comparison unit 316 when there is a restart marker, calculates the data shift value for accessing the data to be processed next, and outputs the same to the data load unit 302, left shift unit 310, fill bit length calculation unit 314, and the comparison unit 316.

The DCT coefficient and/or DC differential value calculation unit 324 calculates the DC differential value and the DCT coefficient from the above information input from the Huffman code detection unit 318 and the SSSS detection unit 320 and outputs the same to the adder 328.

The DCT coefficient and/or DC differential value calculation unit 324 outputs the DC differential value input from the SSSS detection unit 320 as it is to the adder 328 for the DC component. Note that, when the header bit of the differential value being input is negative, it finds the differential value plus one and then fills 1's at the category SSSS plus 1 bit LSB and higher to transform it to a negative number.

For the AC component, if the category SSSS is 0 and the zero run length RRRR is 15, substantially sixteen AC components are made 0, while if the category SSSS is 0 and the zero run length RRRR is 0 too, substantially all remaining AC components are made 0. Also, when the category SSSS is not 0 and the additional data is read, only whether or not the number is negative is checked in same way as that for the DC component mentioned above and that value is output.

The previous DC component value storage unit 326 stores the value of the DC component of the MCU immediately before this time and outputs this to the adder 328.

The adder 328 adds the DC differential value input from the DCT coefficient and/or DC differential value calculation unit 324 and the value of the DC component of the MCU immediately before this input from the previous DC component value storage unit 326 when what is being processed is the DC component, finds the DC component, and outputs the same to the output/output stop switch unit 330. When what is being processed is the AC component, it outputs this as it is to the output/output stop switch unit 330.

The output/output stop switch unit 330 sequentially outputs the decoded data input from the adder 328 to the inverse quantizer 400 according to the output enable signal input from the comparison unit 316.

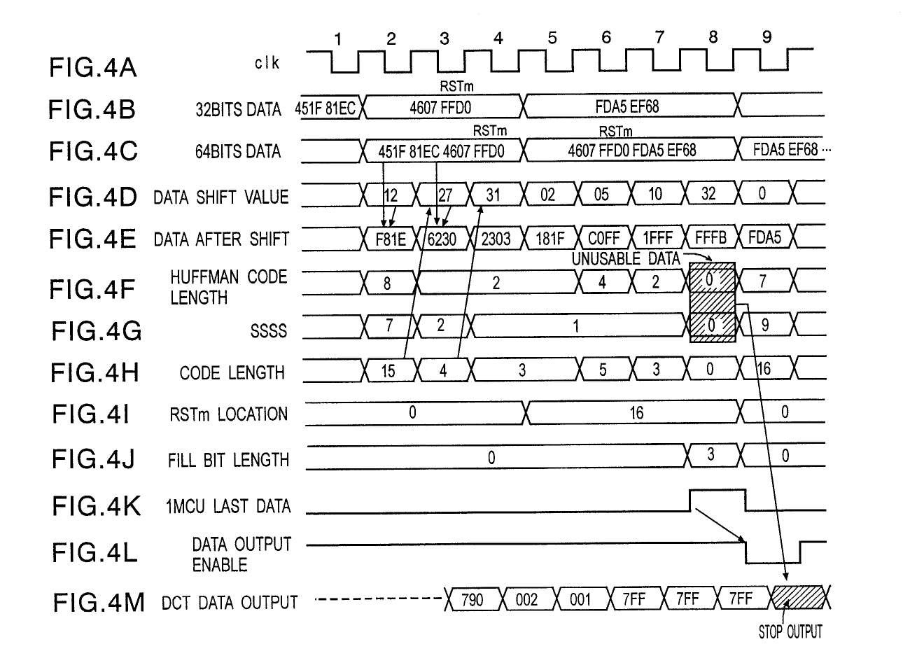

Next, an explanation will be made of the operation of the JPEG decoding apparatus 11 having such a configuration focusing on the operation of the Huffman decoder 300 by referring to FIG. 4.

When data compressed and encoded by the JPEG method read from for example a recording medium is input to the JPEG decoding apparatus 11, it is sequentially stored in the buffer RAM 200 at first.

The data stored in the buffer RAM 200 is read by the data load unit 302 of the Huffman decoder 300 and merged with the data read the previous time and stored in the previous data storage unit 306 at the merge unit 308.

For example, when the Huffman decoder 300 is operating according to the clock as shown in FIG. 4A, when assuming that the 32 bits of data 4607 FFD0h is read at the cycle 2 as shown in FIG. 4B, this is merged with the previously read data 451F81Ech and transformed to 64 bits of data referred to as 451F81EC4607FFD0h as shown in FIG. 4C.

At this time, when assuming that the data shift value has already become 12 as shown in FIG. 4D, the left shift unit 310 shifts this 64 bits of data to the MSB side by 12 bits, extracts the data of the upper significant 16 bits as the result of the shift, and outputs the same to the Huffman code detection unit 318 and the SSSS detection unit 320.

Then, the Huffman code is detected at the Huffman code detection unit 318, the category SSSS is detected at the SSSS detection unit 320 based on this and the data of the SSSS bit is read, the DCT coefficient and the DC differential value are calculated at the DCT coefficient and/or DC differential value calculation unit 324 based on these read data, the DC differential value is added to the DC differential value of the previous MCU stored in the previous DC component value storage unit 326 at the adder 328 and the DC component is calculated, and the data as shown in FIG. 4M is sequentially output via the output/output stop switch unit 330 to the inverse quantizer 400.

At this time, if the code length of the Huffman code detected at the Huffman code detection unit 318 is 8 bits as shown in FIG. 4F and the category SSSS is 7 as shown in FIG. 4G, the code length of one code becomes 15 bits as shown in FIG. 4H. The bit lengths of the processed data are added to the shift value 12 up to then at the adder 322, and thus a new data shift value 27 is obtained.

In the next cycle 3, similar processing is carried out based on this on the upper significant 16 bits of data 6230h obtained by shifting the data stored in the merge unit 308 by 27 bits at the left shift unit 310.

Then, by processing the 3 bits of data comprised by the 2 bits of Huffman code and 1 bit of additional data with respect to the data shifted by 31 bits in the cycle 4, the next shift becomes 34 bits, so exceeds the data length of 32 bits of the data read from the buffer RAM 200. Therefore, the data load unit 302 stores the data read up to then in the previous data storage unit 306 and reads the next data. As a result, the data FDA5EF68h is read from the cycle 5 and merged at the merge unit 308, whereby 64 bits of data referred to as 4607FFD0FDA5EF68h are generated.

Also, at this time, the value of the data shift value is subtracted by 32 and changed to 2 (=34−32).

The data to be processed comprised by the reading of new data is successively processed as explained above and decoded by Huffman decoding.

Note that the restart marker FFD0h is contained in the upper significant 32 bits of this newly merged data. Therefore, the marker detection unit 312 detects this and outputs the information indicating that the restart marker is at the 16th bit from the MSB side as shown in FIG. 4I.

Then, at the cycle 8, when a signal indicating the last data of 1 MCU is input to the fill bit length calculation unit 314 as shown in FIG. 4K, the fill bit length calculation unit 314 subtracts the data shift value (13) (=data shift value (10)+code length (3)) from the location of the restart marker (16), calculates the bit length 3 of the fill bits as shown in FIG. 4J, and outputs the same to the comparison unit 316.

Since the result of addition of the data shift value (13) and the bit length (3) of the fill bits is equal to the location of the restart marker (16), the comparison unit 316 detects that this location is the offset location of the DC component and outputs the clear signal to the previous DC component value storage unit 326. Also, as the cycle for deleting the restart marker, as shown in FIG. 4L, the data output enable signal for the output/output stop switch unit 330 is disabled for one cycle. As a result, the output from the Huffman decoder 300 is stopped for one cycle as shown in FIG. 4M.

Then, by outputting 19 obtained by adding the fill bit length (3) and the data length of the restart marker (16) to the adder 322 by the comparison unit 316, the restart marker is deleted.

In the adder 322, by the addition of the Huffman code length (2) from the Huffman code detection unit 318, additional data bit length (1) from the SSSS detection unit 320, and the deleted data worth's of bit length (16) from the comparison unit 316 to the original data shift value (10), the data shift length 32 is calculated.

Due to this, new data is read again at the data load unit 302, and 32 is subtracted from the data shift length to set it to 0. Due to this, the processing of the next data is carried out from the border of bytes after the restart marker.

In this way, according to the JPEG decoding apparatus 11 of the first embodiment, the restart marker can be suitably detected and deleted.

Second Embodiment

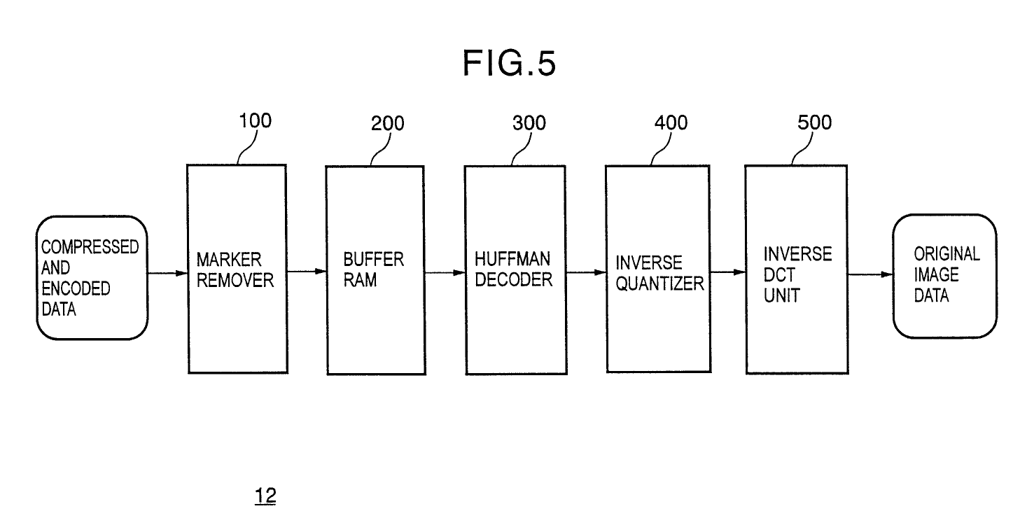

An explanation will be made of the JPEG decoding apparatus of a second embodiment of the present invention by referring to FIG. 5 to FIG. 10K.

In the JPEG decoding apparatus 11 of the first embodiment, it is necessary to stop the data output of the DCT coefficient when deleting the restart marker, so there is a disadvantage of the lag of processing time by the amount of that time. Also, there is a disadvantage in that the circuit configuration and the processing algorithm are relatively complex.

An explanation will be made of an apparatus dealing with such disadvantages and performing similar decoding by a simpler processing and circuit configuration of the second embodiment.

First, an explanation will be made of the overall configuration of the JPEG decoding apparatus of the second embodiment.

FIG. 5 is a block diagram of the configuration of the JPEG decoding apparatus 12.

The JPEG decoding apparatus 12 has a marker remover 100, buffer RAM 200, Huffman decoder 350, inverse quantizer 400, and inverse DCT unit 500.

The marker remover 100 deletes the marker and the additional data 00 after the data FFh from the input JPEG compressed and encoded data, generates a string of pure Huffman codes, and outputs this to the buffer RAM 200. At this time, for the marker, it generates the marker flag indicating its type and location, adds this to the data, and outputs the same together to the buffer RAM 200.

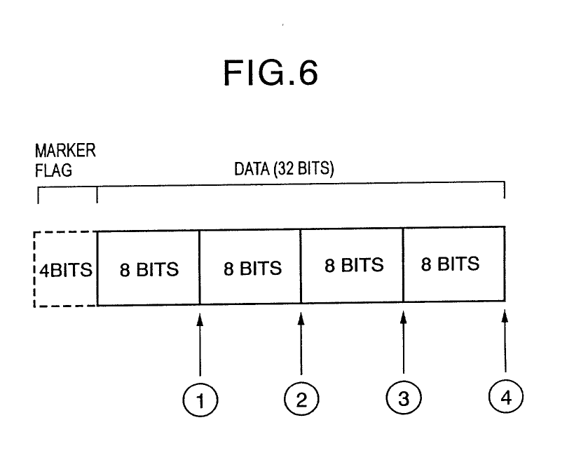

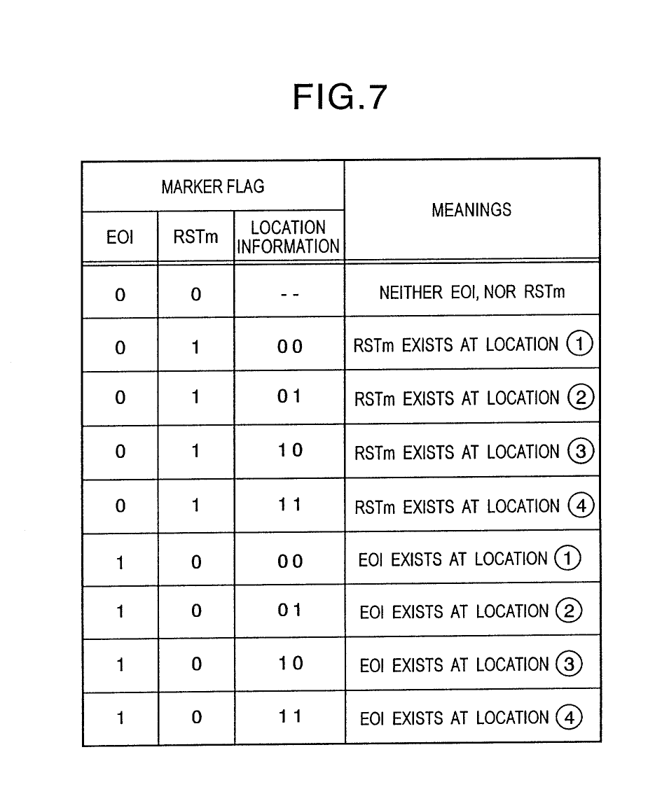

Next, an explanation will be made of this marker flag by referring to FIG. 6 and FIG. 7.

The data input to the JPEG decoding apparatus 12 is the 32 bits of fixed length data. The marker is arranged occupying two bytes at the border of bytes of 32 bits (4 bytes). Accordingly, the location where the marker had existed can be indicated by the border of bytes even for a data stream after the marker was deleted.

Namely, as shown in FIG. 6, the locations where the marker may exist can be defined by four locations <1> to <4> for 4 bytes of the data stream after the marker is deleted. Note that, the left side on the most significant bit side (leftmost side) is defined by the location (<4>) of the right side on the least significant bit side (rightmost side) of the previous data.

Therefore, data with such a marker deleted therefrom is generated as the data. Four bits of the marker flag defined as in FIG. 7 are added to each data.

Note that, it is assumed here that the marker existing in the JPEG stream, that is, the restart marker, and the EOI are detected.

Among the four bits of the marker flag, as shown in FIG. 7, the upper significant 2 bits are used for designating the type of the marker, while the lower significant 2 bits are used for designating the location of arrangement thereof.

Namely, the most significant bit (first bit) 8 indicates that the existing marker is EOI, while the second bit indicates that the existing marker is the restart marker. The numbers 00b to 11b (b indicates binary notation) at the third bit and the fourth bit correspond to the locations <1> to <4> shown in FIG. 6.

Specifically, when for example the upper significant 2 bits of the marker flag are 00b, it is indicated that neither EOI nor a restart marker exist in 32 bits of the data.

Also, the cases where the marker flags are 0100b to 0111b indicate that the restart marker exists at the locations of <1> to <4>.

Also, the cases where the marker flags are 1000b to 1011b indicate that EOI exists at the locations of <1> to <4>.

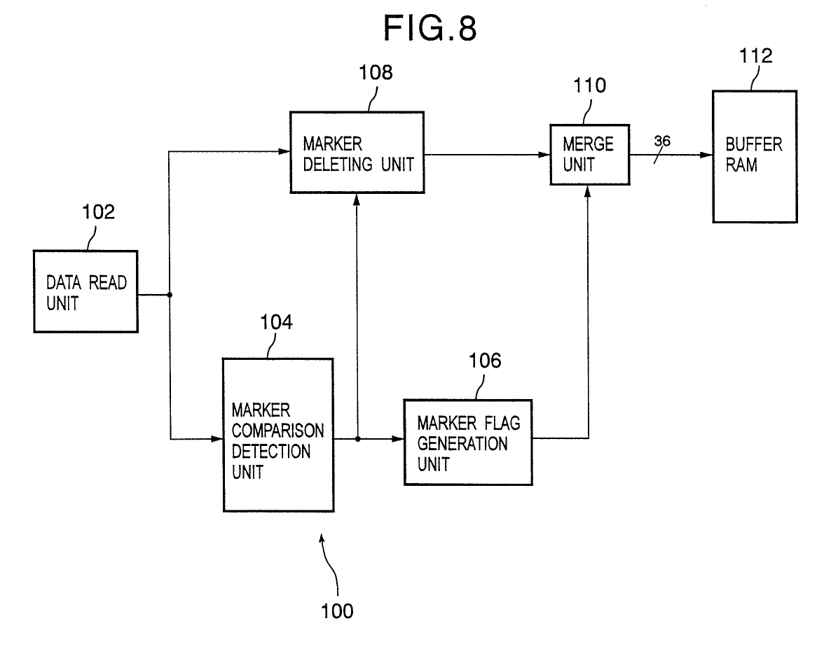

Next, an explanation will be made of the concrete configuration of the marker remover 100 generating such a marker flag and data by referring to FIG. 8.

FIG. 8 is a block diagram of the configuration of the marker remover 100.

The marker remover 100 has a data read unit 102, marker comparison and/or detection unit 104, marker flag generation unit 106, marker deleting unit 108, and merge unit 110.

The data read unit 102 sequentially reads the input 32-bit fixed length JPEG compressed and encoded data and outputs the same to the marker comparison and/or detection unit 104 and the marker deleting unit 108.

The marker comparison and/or detection unit 104 sequentially retrieves the data read by the data read unit 102, detects the restart marker, EOI, and the additional data 00h after the data FFh and outputs the information of the type of the detected data and the detection location to the marker flag generation unit 106 and the marker deleting unit 108.

The marker flag generation unit 106 generates the marker flag based on the information input from the marker comparison and/or detection unit 104 and outputs the same to the merge unit 110.

The marker flag generation unit 106 manages the location of usual encoded data other than the marker and the data 00h sequentially packed into 32 bits of data in the marker deleting unit 108 based on the information input from the marker comparison and/or detection unit 104.

Then, when information indicating the detection of the restart marker or EOI is input from the marker comparison and/or detection unit 104, it detects the location of the marker in the 32 bits of the data newly repacked based on the managed information and generates 2 bits of data indicating the location as explained by referring to FIG. 6 and FIG. 7.

Then, it generates 2 bits of data indicating the type of the marker, merges this to generate 4 bits of the marker flag, and outputs the same to the merge unit 110.

The marker deleting unit 108 deletes the marker and the data 00h from the data input from the data read unit 102 based on the information input from the marker comparison and/or detection unit 104, sequentially packs only the remaining pure Huffman encoded data into 32 bits of fixed length data, and outputs the same to the merge unit 110.

The merge unit 110 merges the 4 bits of the marker flag input from the marker flag generation unit 106 with the data having 32 bits of fixed length input from the marker deleting unit 108 to generate 36 bits of data and outputs the same to the buffer RAM 200.

The above explanation related to the configuration of the marker remover 100.

The buffer RAM 200 temporarily stores 36 bits of data input from the marker remover 100 and sequentially outputs the same to the Huffman decoder 350 upon request.

The Huffman decoder 350 sequentially reads out the compressed and encoded data stored in the buffer RAM 200, performs the decoding, and outputs the same to the inverse quantizer 400. At this time, particularly, the Huffman decoder 350 performs the processing for clearing the DC component value before this by one MCU based on the marker flag contained in the data.

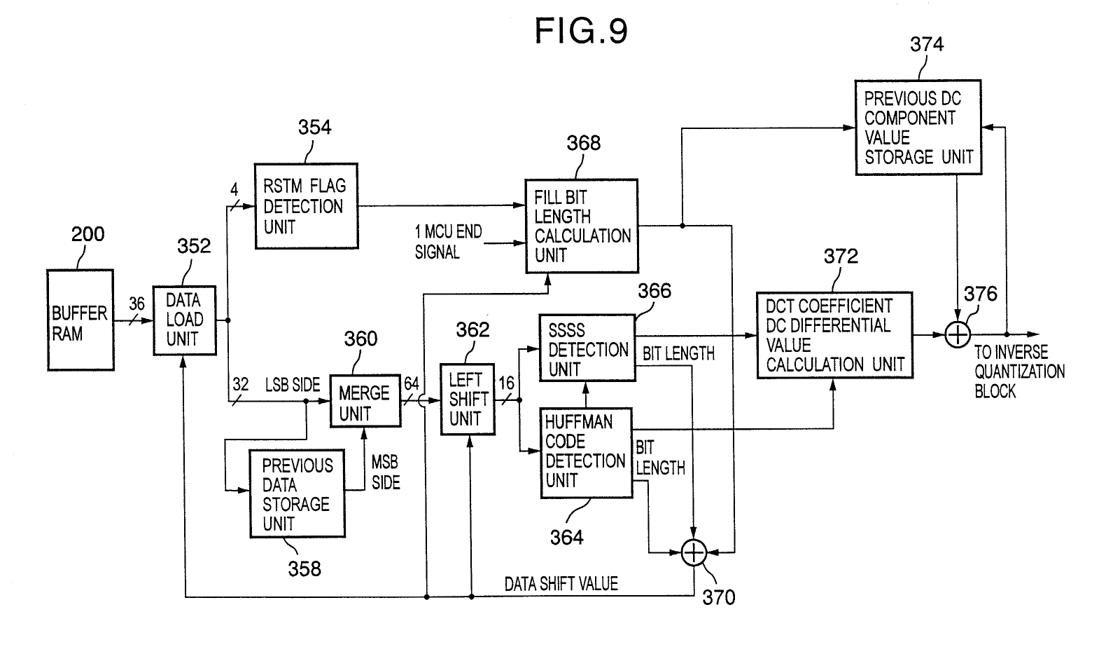

An explanation will be given next of the configuration of this Huffman decoder 350 according to the present invention by referring to FIG. 9.

FIG. 9 is a block diagram of the configuration of the Huffman decoder 350.

The Huffman decoder 350 has a data load unit 352, RSTm flag detection unit 354, previous data storage unit 358, merge unit 360, left shift unit 362, Huffman code detection unit 364, category detection unit (SSSS detection unit) 366, fill bit length calculation unit 368, adder 370, DCT coefficient and/or DC differential value calculation unit 372, previous DC component value storage unit 374, and adder 376.

The data load unit 352 sequentially reads 32-bit amounts of data from the buffer RAM 200, outputs the marker flag of the upper significant 4 bits to the RSTm flag detection unit 354, and outputs the encoded data of the lower significant 32 bits to the previous data storage unit 358 and the merge unit 360. The data load unit 302 reads the next data from the buffer RAM 200 when the data shift value input from the adder 370 becomes more than the bit length of the encoded data portion of the data to be loaded, that is, when it becomes 32 or more.

The RSTm flag detection unit 354 detects information indicating that the restart marker exists from the marker flag input from the data load unit 352 and outputs the detection result thereof and the information of the existing location to the fill bit length calculation unit 368.

The configurations and operations of the previous data storage unit 358, merge unit 360, left shift unit 362, Huffman code detection unit 364, SSSS detection unit 366, DCT coefficient and/or DC differential value calculation unit 372, and the adder 376 are the same as the configurations and operations of the previous data storage unit 306, merge unit 308, left shift unit 310, Huffman code detection unit 318, SSSS detection unit 320, DCT coefficient and/or DC differential value calculation unit 324, and the adder 328 of the first embodiment mentioned before, so the explanations will be omitted.

The fill bit length calculation unit 368 calculates the fill bit length based on the location of the restart marker input from the RSTm flag detection unit 354 and the data shift value calculated at the adder 370 and outputs the same to the adder 370. When processing the data of the tail end of 1 MCU based on a signal indicating the end of 1 MCU separately input from the outside, the fill bit length calculation unit 368 subtracts the data shift value output from the adder 370 from the location where the restart marker exists input from the RSTm flag detection unit 354 to thereby find the fill bit length.

Also, the fill bit length calculation unit 368 outputs a clear signal to the previous DC component value storage unit 374 to clear the DC component when detecting this state, that is, when processing the data on the tail end of 1 MCU.

The adder 370 adds the data having the bit lengths of the processed data input from the Huffman code detection unit 364 and the SSSS detection unit 366 and the data having the fill bit length input from the fill bit length calculation unit 368 when the restart marker exists, calculates the data shift value for accessing the data to be processed next, and outputs the same to the data load unit 352, left shift unit 362, and the fill bit length calculation unit 368.

The previous DC component value storage unit 374 stores the value of the DC component of the MCU immediately before this and outputs the same to the adder 376. Then, the value of the DC component is appropriately cleared based on the clear signal from the fill bit length calculation unit 368.

The above explanation was made for the configuration of the Huffman decoder 350.

The inverse quantizer 400 inversely quantizes the encoded data input from the Huffman decoder 350, generates the string of the DCT coefficients, and outputs the same to the inverse DCT unit 500.

The inverse DCT unit 500 performs inverse DCT with respect to the DCT coefficients input from the inverse quantizer 400, generates the pixel data, and outputs the same as the decoded image data.

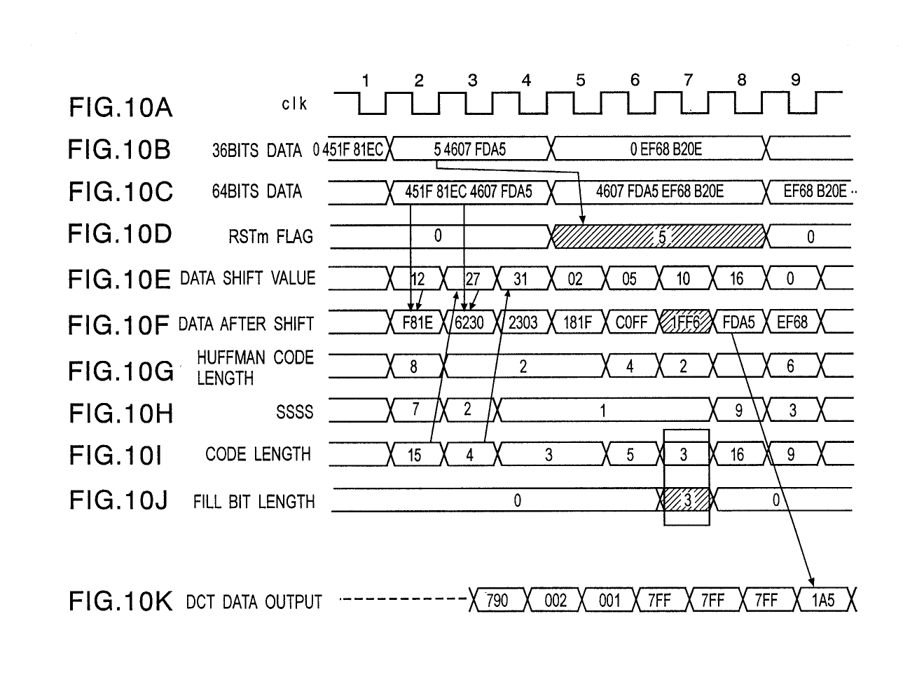

Next, an explanation will be made of the operation of the JPEG decoding apparatus 12 having such a configuration by referring to FIGS. 10A to 10K.

When data compressed and encoded by the JPEG method read out from for example a recording medium is input to the JPEG decoding apparatus 12, it is first read into the marker remover 100, then the restart marker, EOI, and the data 00h to be added to the data FFh are detected at the marker comparison and/or detection unit 104. Then, based on this detection result, these marker and data 00h are all deleted from the data stream at the marker deleting unit 108, and only pure Huffman encoded data are sequentially recomposed as 32 bits of the fixed length data.

Also, the marker flag generation unit 106 generates the 4 bits of the marker flag indicating the type and the location of the marker.

These 4 bits of the marker flag and 32 bits of data are merged at the merge unit 110 and temporarily stored in the buffer RAM 200 as 36 bits of data.

The data stored in the buffer RAM 200 is read out by the data load unit 352 of the Huffman decoder 350, the marker flag is output to the RSTm flag detection unit 354, and the data is output to the previous data storage unit 358 and the merge unit 360.

The data output to the merge unit 360 is merged with the data stored in the previous data storage unit 358 read the previous time at the merge unit 360.

For example, when the Huffman decoder 350 is operating according to the clock as shown in FIG. 10A, when assuming that the 36 bits of the data 54607FDA5h are read in cycle 2 as shown in FIG. 10B, the most significant 4 bits, that is, the data 5h, are input to the RSTm flag detection unit 354, and the remaining 32 bits of data are merged with the data 451F81ECh stored in the previous data storage unit 358 to obtain the 64 bits of the data 451F81EC4607FDA5h as shown in FIG. 10C.

At this time, if the data shift value has already become 12 as shown in FIG. 10E, the left shift unit 362 shifts the 64 bits of the data by 12 bits to the MSB side, extracts the upper significant 16 bits of data as the result of the shift as shown in FIG. 10F, and outputs the same to the Huffman code detection unit 364 and the SSSS detection unit 366.

Then, the Huffman code is detected at the Huffman code detection unit 364, the category SSSS is detected at the SSSS detection unit 366 based on this, the SSSS bits of the data are read out, the DCT coefficient and DC differential value are calculated at the DCT coefficient and/or DC differential value calculation unit 372 based on these read data, the DC differential value is added to the DC differential value of the previous MCU stored in the previous DC component value storage unit 374 at the adder 376 to calculate the DC component, and the data as shown in FIG. 10K is sequentially output to the inverse quantizer 400.

At this time, if the code length of the Huffman code detected at the Huffman code detection unit 364 is 8 bits as shown in FIG. 10G and the category SSSS is 7 as shown in FIG. 10H, the code length of one code becomes 15 bits as shown in FIG. 101. The bit length of the processed data is added to the shift value 12 up to then at the adder 370 to obtain new data shift value 27.

Based on this, in the next cycle 3, similar processing is carried out with respect to the data 6230h of the upper significant 16 bits of the data obtained by shifting the data merged at the merge unit 360 by 27 bits at the left shift unit 362.

Then, by processing the 3 bits of the data comprised by the 2 bits of the Huffman code and 1 bit of additional data for the data shifted by 31 bits at cycle 4, the next shift amount becomes 34 bits and exceeds the data length 32 bits of the actual encoded data read from the buffer RAM 200. Therefore, the data load unit 352 stores the data read up to then in the previous data storage unit 358 and reads the next data. As a result, data is generated where the data portion is EF68B20Eh is read from cycle 5 and merged at the merge unit 360 and where 64 bits of data such as 4607FDA5EF68B20Eh.

Also, at this time, the data shift value is decremented by 32 and changed to 2 (=34−32).

The data to be processed comprised by the reading of new data is sequentially processed as mentioned above and decoded by Huffman decoding at cycle 5 to cycle 7.

The marker flag which was added to this newly merged data and previously input to the RSTm flag detection unit 354 was 5. This is the flag indicating that the restart marker exists at the 16th bit from the MSB side as explained by referring to FIG. 6 and FIG. 7. Accordingly, the RSTm flag detection unit 354 detects this as shown in FIG. 10D simultaneously with the corresponding data being merged and arranged in the upper significant 32-bit portion.

Then, when the signal indicating the last data of 1 MCU is input to the fill bit length calculation unit 314 at cycle 7, the fill bit length calculation unit 368 subtracts the data shift value (13) (=data shift value (10)+code length (3)) at that time from the location of restart marker (16), calculates the bit length 3 of the fill bit as shown in FIG. 10J, and outputs the same to the adder 370 and simultaneously outputs a clear signal to the previous DC component value storage unit 374.

The adder 370 adds the Huffman code length (2) from the Huffman code detection unit 364, the additional data bit length (1) from the SSSS detection unit 366, and the fill bit length (3) from the fill bit length calculation unit 368 to the original data shift value (10) so as to calculate the data shift length 16.

Due to this, the data to be newly processed is extracted at the left shift unit 362, and the next data is decoded in the same way as up to then.

In this way, in the JPEG decoding apparatus 12 of the second embodiment, in the same way as the JPEG decoding apparatus 11 of the first embodiment, the restart marker can be suitably detected and deleted.

Then, particularly, as clear from FIG. 9, the circuit configuration of the Huffman decoder 350 can be simplified and the processing can be facilitated.

Accordingly, it is very effective particularly when such JPEG decoding apparatus 12 or Huffman decoder 350 is comprised on an LSI or the like.

Also, as clear from FIGS. 10A to 10K, the data is sequentially successively output from the Huffman decoder 350. Namely, there is no waiting for output due to the processing of the marker etc. Accordingly, the decoding can be carried out at a higher speed.

Note that, the present invention is not limited to the present embodiments and can be modified in various ways.

For example, in the above embodiments, processing with respect to a restart marker contained in a JPEG data stream was indicated. However, the present invention is not limited to the types of the data stream and marker. It can be applied to any encoded data stream having a control code such as a restart marker in the data stream.

Also, the present invention can be applied to any apparatus such as a camera system for processing a still image, image reproducing apparatus, and an image recording and/or reproducing apparatus.

In addition, the detailed configurations of the marker remover and the Huffman decoder, the detailed configuration of the JPEG decoding apparatus, and so on can be freely changed.

In this way, according to the present invention, by detecting and deleting the marker code at a high speed by a simple circuit, a data decoding apparatus having a simple circuit configuration and performing processing at a high speed can be provided.

Also, by detecting and deleting the marker code at a high speed by a simple circuit, a data decoding method with a simple circuit configuration and high processing speed can be provided.

While the invention has been described with reference to specific embodiment chosen for purpose of illustration, it should be apparent that numerous modifications could be made thereto by those skilled in the art without departing from the basic concept and scope of the invention.

What is claimed is:

1. A data decoding apparatus, comprising:
an additional data detecting means for detecting additional data from an encoded data stream including encoded data and additional data;
an additional data deleting means for deleting said additional data from said encoded data stream,
an additional data flag generating means for generating an additional data flag indicating a type and a position of said detected additional data based on said detection result, and
a decoding means for carrying out predetermined processing with respect to the encoded data stream from which said additional data is deleted based on said generated additional data flag and performing to decode the encoded data stream.

2. A decoding apparatus as set forth in claim 1, wherein said additional data flag generating means selects additional data required in the decoding in said decoding means from said detected additional data and generates said additional data flag with respect to only the related selected additional data.

3. A decoding apparatus as set forth in claim 2, wherein;
said encoded data is encoded data utilizing a differential value from predetermined reference data,
said additional data is control data for resetting said reference data, and
said decoding means resets the reference data at a predetermined position specified by said additional data flag with respect to said encoded data stream and decodes the encoded data utilizing said differential value.

4. A decoding apparatus as set forth in claim 3, wherein;
said encoded data stream is a data stream obtained by processing a desired still image for every predetermined unit area by discrete cosine transformation, quantization, variable length coding, insertion of predetermined additional data, and transformation to a series of fixed length data having a predetermined bit length, and
said decoding means extracts said variable length coded data from said data stream, decodes said encoded data by variable length decoding, and restores the series of the discrete cosine transformed and quantized data.

5. A decoding method, comprising the steps of:
detecting additional data from an encoded data stream including encoded data and additional data;
deleting said additional data from said encoded data stream, generating an additional data flag indicating a type and a position of said detected additional data based on said detection result; and
carrying out predetermined processing with respect to the encoded data stream from which said additional data is deleted based on said generated additional data flag to decode the encoded data stream.

6. A decoding method as set forth in claim 5, wherein said generation of additional data flag comprises selecting additional data required in the decoding from said detected additional data and generating said additional data flag with respect to only the related selected additional data.

7. A decoding method as set forth in claim 6, wherein;
said encoded data is encoded data utilizing a differential value from predetermined reference data,
said additional data is control data for resetting said reference data, and
said decoding comprises the steps of
resetting the reference data at a predetermined position specified by said additional data flag with respect to said encoded data stream, and
decoding the encoded data utilizing said differential value.

8. A decoding method as set forth in claim 7, wherein:
said encoded data stream is a data stream obtained by processing a desired still image for every predetermined unit area by discrete cosine transformation, quantization, variable length coding, insertion of predetermined additional data, and transformation to a series of fixed length data having a predetermined bit length, and
said decoding comprises the steps of
extracting said variable length coded data from said data stream,
decoding the related encoded data by variable length decoding, and
restoring the series of the discrete cosine transformed and quantized data.
